(19) United States
(12) Patent Application Publication
(10) Pub. No.: US 2017/0092253 A1
(43) Pub. Date: Mar. 30, 2017

(54) KARAOKE SYSTEM

(71) Applicant: FOODMOB PTE. LTD., Singapore (SG)

(72) Inventors: Rahn WOOD, Ho Chi Minh City (VN); To Thuy TRANG, Ho Chi Minh City (VN)

(73) Assignee: FOODMOB PTE. LTD., Singapore (SG)

(21) Appl. No.: 15/259,975

(22) Filed: Sep. 8, 2016

(30) Foreign Application Priority Data
Sep. 25, 2015 (SG) 10201508004Y

(51) Int. Cl. G10H 1/36; H04N 5/91; G11B 27/031; H04N 5/77

(52) U.S. Cl. CPC G10H 1/368; H04N 5/772; H04N 5/91; G11B 27/031; G10H 1/366; G10H 2220/011

(57) ABSTRACT

A karaoke system comprises a karaoke box coupled to a screen and an amplifier. The karaoke box is arranged to display an output image on the screen and is further arranged to emit output audio on the amplifier. A microphone is coupled to the amplifier and in use it enables a karaoke performer to perform a karaoke performance. The system has one or more mobile devices being in communication with the karaoke box. Each mobile device is arranged to transmit an additional image or additional audio to the karaoke box. The additional image is combined with the output image displayed on the screen and the additional audio is combined with the output audio emitted on the amplifier. A recording unit is arranged to compile a recording of the combined output audio and additional audio and a processing unit is arranged to store the recording.

### TECHNICAL FIELD

The present invention relates to a karaoke system.

More particularly, the present invention relates to a karaoke system capable of recording sound and video.

### BACKGROUND ART

Karaoke entertainment systems have been popular for many years as they provide users with the ability to select songs, typically well-known modern pop songs, from which the original musician's lead vocal track has been removed so that the user can sing along to the music track and hear the ‘modified’ song in their own voice. The user is assisted in singing the correct words by having the lyrics displayed on a television screen, along with a moving symbol to guide the user.

Karaoke entertainment systems are often provided in commercial establishments such as hotels and dedicated karaoke bars. Other home-based karaoke entertainment systems have also proliferated in recent years as popularity of karaoke has grown and audio-visual technology has become more affordable. More recently with the increasing popularity of social media and online video, karaoke song databases have been available for usage via the internet and through mobile smartphone applications designed for individual/private use, that can include audio and/or video recording. Some prior art karaoke systems include audio-visual recording capabilities or chroma key (aka green screen) capabilities but these are not readily available in integrated systems and do not permit recordings to be made or easily shared via social networking.

US 2014/0069261 discloses a karaoke system having a hub coupled to a display and a plurality of mobile devices, whereby the output of the mobile devices can be combined into a single output. However, there is no teaching of a video recording capability or sharing via social networking. A drawback of this system is that it uses the microphones of the mobile devices and thus tends to produce low quality audio output.

US 2015/0037777 discloses a karaoke system also including a camera to detect user motion. The system is arranged to compare a user's actions and dialogue to an original video clip and then scores the user on the quality of action and dialogue in comparison to that of the original. However, this system does not permit additional input from other parties or devices and does not enable recording or sharing of a resultant recording.

US 2014/0298174 discloses a video karaoke system whereby multiple users can join a unified system and each upload their own videos for viewing by the other users so that the other users can score each of the karaoke performances. However, this system does not permit the other users to provide a direct input into the performance of a specific user. Nor does it permit sharing of the performance with other parties.

It is to be understood that, if any prior art publication is referred to herein, such reference does not constitute an admission that the publication forms a part of the common general knowledge in the art in any country.

### SUMMARY OF THE INVENTION

According to one aspect, there is provided a karaoke system comprising:
a karaoke box coupled to a screen and to an amplifier, wherein the karaoke box is arranged to display an output image on the screen and is further arranged to emit output audio on the amplifier;
a microphone coupled to the amplifier, in use enabling a karaoke performer to perform a karaoke performance;
one or more mobile devices being in communication with the karaoke box, each mobile device being arranged to transmit an additional image or additional audio to the karaoke box, wherein the additional image is combined with the output image displayed on the screen and the additional audio is combined with the output audio emitted on the amplifier;
a recording unit being arranged to compile a recording of the combined output audio and additional audio; and
a processing unit arranged to store the recording.

The recording may be compiled to include the combined output image and the additional image.

The recording unit may comprise a video camera being arranged to record a video of the karaoke performer, and wherein the recording is compiled to include the video.

The karaoke system may comprise a chrome key screen arranged to form a background against which the video of the karaoke performer is recorded.

The recording unit may be arranged to superimpose the video of the karaoke performer onto a background image.

The background image may be an image uploaded to the recording unit by the karaoke performer.

The recording unit may be arranged to display the recording on the screen so that, in use, the karaoke performer can review the recording in real-time during the karaoke performance.

The recording unit may comprise editing software enabling the recording to be edited.

The processing unit may be arranged to display the edited recording on the screen so that, in use, the karaoke performer can review the edited recording after the karaoke performance is finished.

The processing unit may be arranged to display the edited recording on one or more of the mobile devices.

The processing unit may be arranged to make the recording available to third parties for download.

The processing unit may be arranged to make the recording available through a social media portal.

The processing unit may be arranged to make only a part of the recording available.

The additional image may comprise text messages, icons, pictures, animation or video segments.

The additional audio may comprise sound clips or sound effects.

According to another aspect, there is provided a method for operating a karaoke system comprising the steps of:
a) selecting a karaoke song to be performed;
b) emitting an audio track of the karaoke song over a speaker;
c) displaying lyrics for the karaoke song on a screen to enable a karaoke performer to sing a substitute vocal track, wherein the substitute vocal track is also emitted over the speaker superimposed on the audio track;
d) enabling an additional user to generate an additional image or additional audio, wherein the additional image is combined with the lyrics displayed on the screen and the additional audio is combined with the substitute vocal track emitted on the speaker;
e) compiling a recording of the combined audio track, substitute vocal track and additional audio; and
f) storing the recording.

The method may include the step of compiling the recording to include the additional as image.

The method may include the step of transmitting the additional image or additional audio from a mobile device that is in communication with the karaoke system.

The method may include the step of capturing a video of the karaoke performer and combining the video with the recording.

The method may include the step of capturing the video of the karaoke performer on a chroma key background thereby enabling the video to be superimposed on a background image.

The method may include the step of the karaoke performer uploading the background image onto which the video is superimposed.

The method may include the step of editing the recording.

The method may include the step of enabling the recording to be accessed by third parties or distributed to third parties via social media.

### BRIEF DESCRIPTION OF THE DRAWINGS

The present invention will now be described, by way of example, with reference to the accompanying schematic drawings, in which:

FIG. 1 is a diagrammatic representation of a karaoke system according to an embodiment of the present invention;

FIG. 2 is a block diagram of hardware components used in a shop providing use of the karaoke system shown in FIG. 1;

FIG. 3 is a block diagram of functional components used in the karaoke system shown in FIG. 1; and

FIGS. 4 to 10 show flow diagrams illustrating progressive steps in using the karaoke system shown in FIG. 1.

### DETAILED DESCRIPTION OF SPECIFIC EMBODIMENTS

Referring to the drawings, there is shown a karaoke system 100 that is arranged to enable a karaoke performer to make an audio recording and/or an audio-visual recording of their performance in a digital format, to permit interaction with third parties whilst making the recording so that those third parties can provide audio and visual input into the recording, and subsequently to make the recording available or distribute the recording via social media.

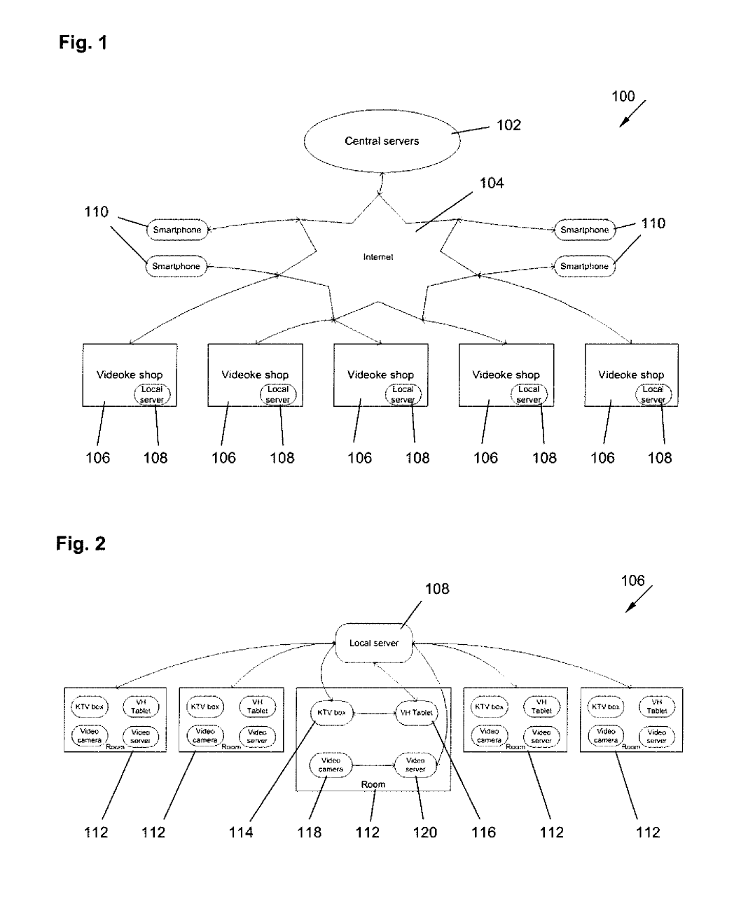

As shown in FIG. 1, the karaoke system 100 comprises a central server 102 being in communication with the Internet 104 so that it can establish data communication channels with respective shops 106, in which karaoke can be performed by the karaoke performer. Each shop 106 has its own local server 108. Also, many karaoke performers may own data enabled mobile devices, such as smartphones 110, that are also able to establish data communication channels via the Internet 104 either with the central server 102 and/or with the local servers 108. It will be appreciated that other types of mobile devices could also be utilised instead of the smartphones 110, such as tablet computers or iPads, PDA's (personal digital assistants) and or laptop computers.

It is envisaged that the karaoke system 100 could also be utilised as a home unit for private use in a household. In such case only one local server will be provided for use in a single household.

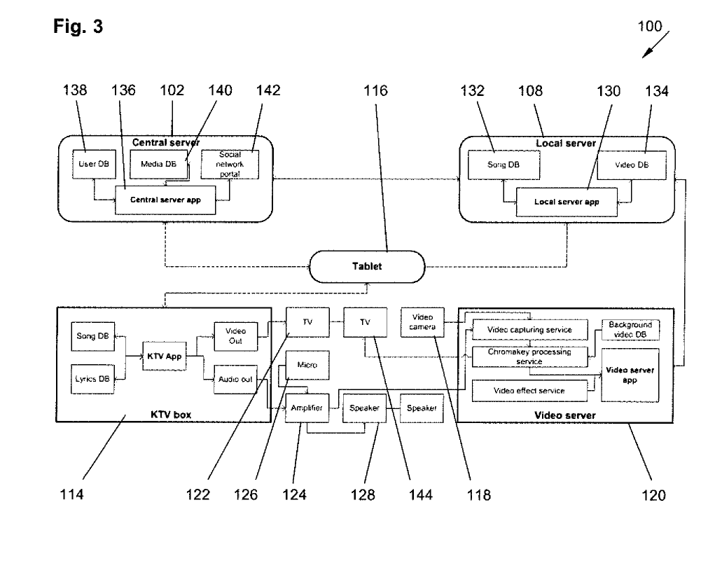

With reference to FIG. 2, each shop 106 will normally provide numerous rooms 112 in which karaoke can be performed. Thus each shop 106 can simultaneously accommodate numerous groups of patrons who wish to conduct karaoke performances in the rooms 112. Each of the rooms 112 is provided with hardware enabling such a karaoke performance to be conducted in conventional manner as well as being provided with additional hardware permitting an audio recording or an audio-visual recording to be made of the karaoke performance. Accordingly each room is provided with a KTV box 114 (otherwise known as a karaoke box), a tablet 116 (VH tablet), a video camera 118 and a video server 120. Each room 112 will further include audio visual equipment (see FIG. 3) comprising a display screen, such as a television 122, an amplifier 124, a microphone 126 and a speaker 128. Multiple screens, microphones or speakers can be provided in each of the rooms 112.

The local server 108 is in communication with both the KTV box 114 and the tablet 116, the latter also being in communication with each other so that the tablet 116 can be operated to cause information and data to be transmitted from the local server 108 to the KTV box 114 for display of images on the television 122 and playing of audio over the amplifier 124. Similarly, the local server 108 is in communication with the video server 120 for receiving and sending video recordings between the local server 108 and the video server 120. The video server 120 is arranged to receive video from the video camera 118 and to output images to the television 122. Although the local server 108 and the video server 120 are illustrated as separate components in FIG. 3, it should be appreciated that they may be contained on a common computer server unit with the distinction merely being software based.

Referring to FIG. 3, each local server 108 comprises conventional server hardware, such as a processor (CPU) being arranged to process computer instructions to run a local server application 130, and memory enabling running of the local server application 130 and for storing a data. The memory is arranged to store one or more databases. In the exemplary embodiment, the memory stores a song database 132 and a video database 134. The song database 132 is arranged to store a supply of karaoke songs that can be played through the KTV box 114 and is further arranged to receive and store audio data generated by the karaoke performer whilst singing the karaoke song. As is well known in the art, a karaoke song is conventionally an “empty track” that only contains the music track but no vocal track, thereby allowing the karaoke performer to sing the vocal track during the karaoke performance. The video database 134 is arranged to store a supply of video backgrounds and to receive and store a video recording received from the video server 120. It should be understood that in other embodiments the song database 132 and the video database 134 can be combined into a single comprehensive database. The local server application 130 operates as an interface for the song database 132 and the video database 134. The local server application 130 can be displayed on the tablet 116, on the smartphone 110 of the karaoke performer or on each of the smartphones 110 of the third parties observing or interacting with the karaoke performer. The tablet 116 will typically be provided with the room 112 for use by patrons who do not own a smartphone 110.

The central server 102 also comprises conventional server hardware, such as a processor (CPU) being arranged to process computer instructions to run a central server application 136, and memory enabling running of the central server application 136 and for storing a data. In the exemplary embodiment the memory is arranged to store a user database 138 and a media database 140. The central server 102 further comprises a social network portal 142 permitting communication with a social network.

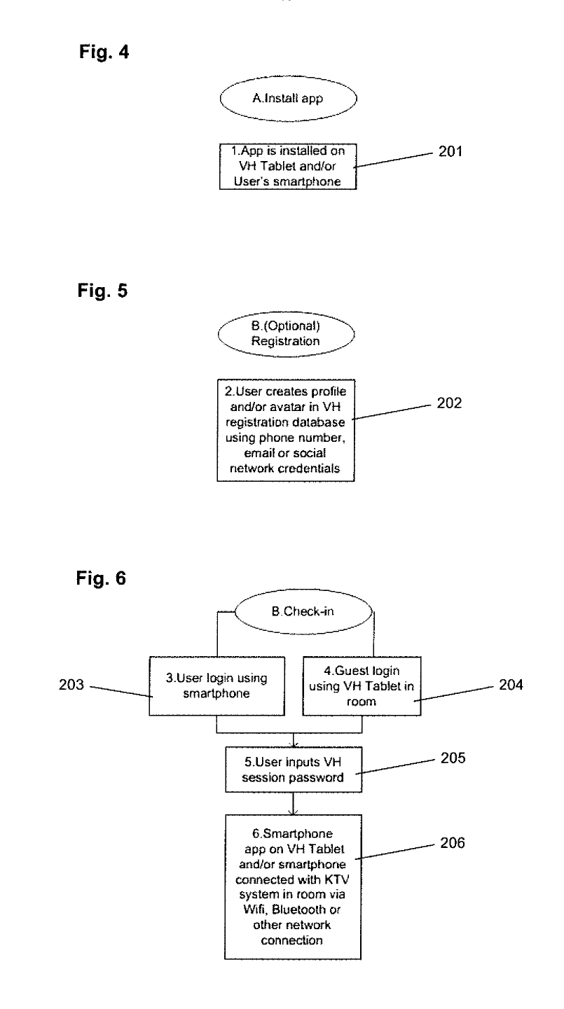

The operational use of the karaoke system 100 will now be described with reference to FIGS. 4 to 10. In a first step 201 the local server application 130 is downloaded and installed on the tablet 116 and/or on the or each smartphone 110. The local server application 130 can either be downloaded directly from the local server 108 or can be obtained from a commercial application store such as the Apple App Store, the Microsoft Store or Google Play.

In step 202 the karaoke performer can optionally register on the central server 102 to create a reusable user profile in the user database 138. Such a profile would enable the karaoke performer to save personal preferences on how they wish to perform karaoke and also enables any performances to be saved in the media database 140. Such a profile will be created in a standard manner known in the art, e.g. normally utilising a phone number, email address, or other social network credentials with related passwords to identify the karaoke performer.

Once the local server application 130 is installed, the karaoke performer does a login on the tablet 116 or smartphone 110. If the karaoke performer has registered a user profile in step 201, then user login 203 loads the user profile into the local server application 130. Alternatively, if no user profile has been registered, then guest login 204 loads generic preferences. The generic preferences may be altered for a specific performance or session but these alterations will not be saved and will be discarded at the end thereof.

In step 205 the karaoke performer inputs their session password into the local server application to activate their karaoke session. Such a session password is directed to prevent unauthorised use of the karaoke system 100 and also to implement a time restraint on such authorised use. If the karaoke system 100 is a standalone home unit, then the input of such a session password is not needed and this step can be bypassed, whereby the session is activated automatically as soon as login has been done.

Activation of the session initiates a connection from the local server 108 to the KTV box 114. The karaoke performer is then able to select a desired karaoke performance format. This could be either a singing performance (described in steps 207 to 213 hereinafter) as per a conventional karaoke performance, or a singing with recording performance (described in steps 214 to 226 hereinafter), which recording is captured (described in steps 227 to 234 hereinafter). When only a singing performance is selected it will not be possible to share the performance with others via social media. However, if the singing with recording performance is selected, the karaoke performer will have the further option of sharing the recorded performance via social media (described in steps 235 to 244 hereinafter).

The karaoke system 100 allows additional users to join the same session as that of the karaoke performer as interactive observers. In order to do so they will need to have their own smartphones 110, or additional tablets 116 will need to be provided in each room 112, whereby the additional users will also need to login and join the same active session. This could require them inputting the same session password when the karaoke system 100 is in commercial use, but otherwise could simply be a selection item when the karaoke system 100 is a home unit.

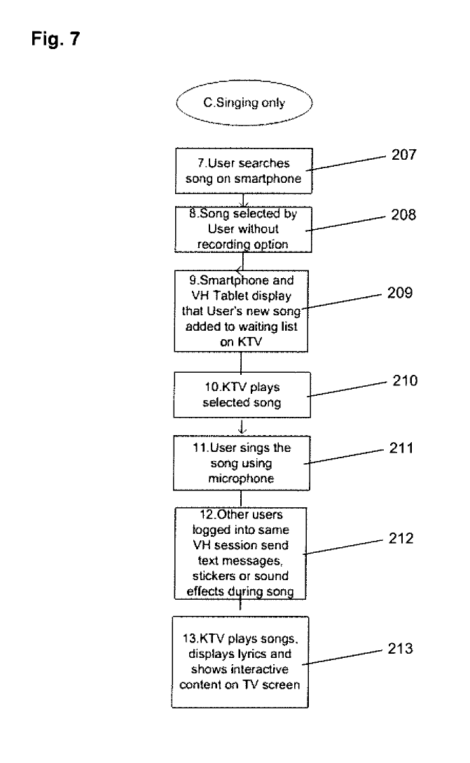

The steps 207 to 213 of the singing performance are shown in FIG. 7. The karaoke performer uses the local server application 130 to search 207 through the song database 132 and selects 208 a desired karaoke song to perform. Such a karaoke song could also be a karaoke audio file requiring speech instead of singing, e.g. using a movie clip. The selected karaoke song is transferred to the KTV box 114 where it is put in a sequential waiting list and this is confirmed by displaying a message 209 on the tablet 116 or smartphone 110. When its turn arrives, the selected karaoke song is played 210 by the KTV box 114. in normal karaoke manner, the KTV box 16 outputs the empty music track to the amplifier 124 so that the music track is played over the speaker 128 without any vocal track. Simultaneously, the lyrics of the vocal track are displayed on the television 122, with the lyrics being synchronised with the music track so that the karaoke performer can read the lyrics and sing 211 their own substitute version of the vocal track into the microphone 126. The substitute vocal track is then superimposed on the music track to generate the karaoke performance.

In step 212, while the singing is being performed, any other interactive observer users can provide additional input, such as additional images or additional audio, to the karaoke performance by sending such additional input to the KTV box 114. Such an additional image can take the form of text messages, icons, pictures, animation or video segments, which are displayed on the television 122 by the KTV box 114 together with the lyrics. Alternatively the additional input can include sound clips or sound effects that the KTV box 114 outputs to the amplifier 124. The KTV box 114 will not delay the additional input and thus the messages/images and the sound effects will be transmitted 213 almost immediately in real-time and form an interactive part of the karaoke performance.

It will be appreciated that the additional input can have various purposes. One purpose may be to provide training whereby a teacher can provide instructions to the karaoke performer. Another purpose could be to supplement and improve the performance by adding beneficial sound effects or providing alternate text to be sung, thereby “jazzing up” the performance. Yet another purpose could be comical to introduce humour into the karaoke performance.

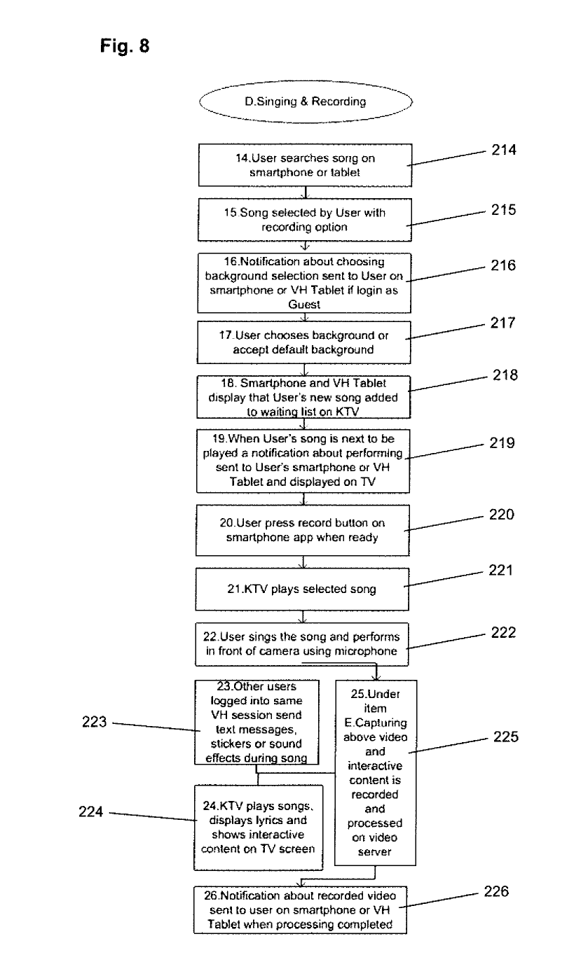

The steps 214 to 226 of the singing with recording performance are shown in FIG. 8. The karaoke performer uses the local server application 130 to search 214 through the song database 132 and selects 215 a desired song to perform. At the same time the karaoke performer indicates that the performance is to be recorded—this could be by simply selecting a toggle switch or tick box in the local server application 130. An additional option is displayed notifying 216 the user that they can select a background video on which their image can be superimposed. In one embodiment the background image is obtained from a database stored on the local server 108, but in another embodiment the background image can be supplied by the karaoke performer and uploaded to the local server 108 via the smartphone 110. The karaoke performer selects 217 the desired background image or, if no selection is made, a default background image is allocated. The background image can be a still image or a movie video, e.g. having a stage with musicians thereon or a cheering crowd.

The selected song and background image are transferred to the KTV box 114 where they are put in a sequential waiting list and this is confirmed by displaying a message 218 on the tablet 116 or smartphone 110. When its turn arrives, a notification 219 is sent to the karaoke performer to take up the appropriate position in front of the video camera 118. When in position, the karaoke performer presses a record button 220 so that the selected karaoke song is played 221 by the KTV box 114. Again, in normal karaoke manner, the KTV box 114 outputs the empty music track to the amplifier 124 so that the music track is played over the speaker 128 without any vocal track. Simultaneously, the lyrics of the vocal track are displayed on the television 122, with the lyrics being synchronised with the music track so that the karaoke performer can read the lyrics and sing 222 their own substitute vocal track into the microphone 126 while dancing and performing in front of the video camera 118. The substitute vocal track is then superimposed on the music track to generate the karaoke performance.

In one embodiment, the background image can be displayed on a further screen located behind the karaoke performer so that the video camera 118 records both the karaoke performer and the background image together. However, in a preferred embodiment the karaoke performer will perform in front of a chrome key screen so that the video recording can be superimposed over the background image during post-production processing.

In step 223 and 224, while the performance is being performed, any other interactive observer users can provide additional input, such as additional images or additional audio, into the performance by sending such to the KTV box 114. As above, such additional input can take the form of text messages, icons, pictures, animation or video segments, which are displayed on the television 122 by the KTV box 114 together with the lyrics. Alternatively the additional input can include sound clips or sound effects that the KTV box 114 outputs to the amplifier 124 and speaker 128. The KTV box 114 will not delay the additional input and thus the messages/images and the sound effects will be transmitted almost immediately in real-time and form an interactive part of the karaoke performance.

The video server 120 receives the video input from the video camera 118 as well as the sound input from the amplifier 124 for further processing and recording purposes. Once the performance is finished and the processing is complete, a notification 226 is sent to the karaoke performer that the recording can be viewed and/or shared.

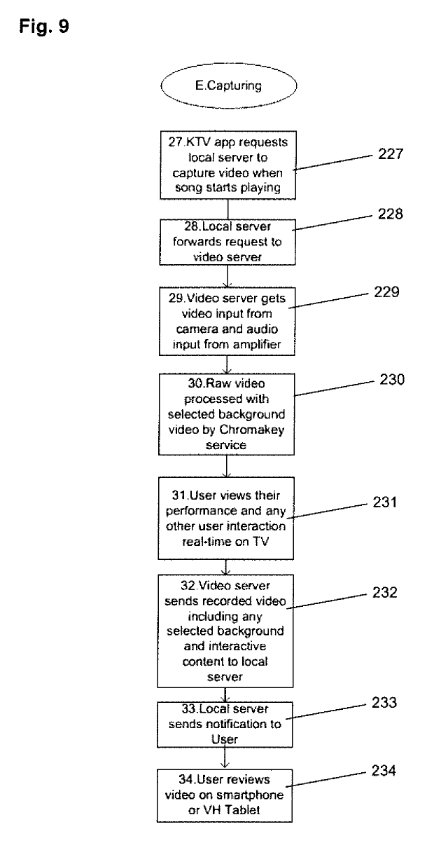

Referring now to FIG. 9, when the karaoke performer presses the record button 220, the KTV box 114 transmits a request 227 to the local server 108, which is relayed 228 to the video server 120 to record 229 the input from the amplifier 124 and the video camera 118. The video server processes 230 the raw video recording to superimpose the chrome key recording of the karaoke performer onto the background image to generate a live recording. This processing can include superimposing the karaoke lyrics, as well as any messages/images submitted by the additional users, onto the background image that are also displayed in the live recording. The live recording is displayed on a screen 144 so that karaoke performer can view 231 their performance in real-time during the performance so that any requisite adjustments or improvements can be made.

In step 232, once the performance is finished the video server 120 transmits the processed video recording to the local server 108 to be saved into memory. The local server application 130 notifies the karaoke performer 233 that the processed video recording is available so that the user can review 234 the recording on the tablet 116 or the smartphone 110. If desired, the processed video recording can be edited, modified or enhanced by special effects.

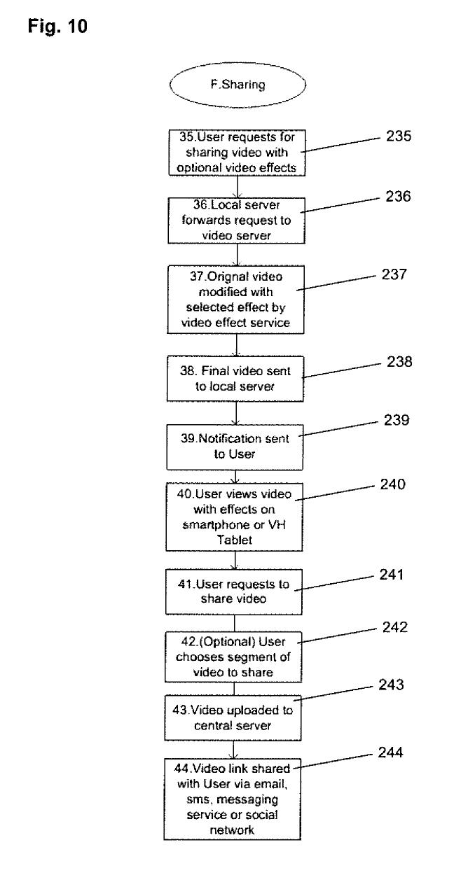

Finally, if the karaoke performer is satisfied, the processed video recording can be shared as per the steps shown in FIG. 10. The karaoke performer selects this sharing option on the local server application 130 in step 235. At such stage the karaoke performer can, if desired, perform more special effects enhancements 237 to modify the processed video recording. These modifications are performed by the video server 120, whereafter the final video recording is sent and stored in the memory on the local server 108. A notification 239 is given to the karaoke performer that the final video recording can be inspected and viewed on either the tablet 116 or the smartphone 110. Additional revisions can be made to improve the final video recording. When satisfied, the karaoke performer requests to share the final video recording 241 and this can be either the entire recording or only a segment of the recording 242. The shared video recording is then uploaded 243 to the central server 102 and saved in the media database 140, whereafter a video link is shared so that third parties can access the shared video recording through the social network portal.

It will be appreciated that all the communication between the central server 102, local server 108, KTV box 114, video server 120 and tablet 116 or smartphone 110 can be by any suitable networking means, either wired or wireless. Thus the communication can be via WiFi or Bluetooth.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A karaoke system comprising:
a karaoke box coupled to an amplifier, wherein the karaoke box is arranged to display an output image and is further arranged to emit output audio on the amplifier;
a video camera coupled to the karaoke box;
a microphone coupled to the amplifier, in use cooperating with the video camera to enable a karaoke performer to perform a karaoke performance comprising a raw video recording;
a chroma key screen forming a background image against which the raw video recording is recorded;
at least one mobile device being in communication with the karaoke box, the mobile device being arranged to transmit an additional image or additional audio to the karaoke box, wherein the additional image is combined with the output image and the additional audio is combined with the output audio emitted on the amplifier;
a recording unit being arranged to compile a processed video recording, wherein the processed video recording combines the raw video recording and the background image, and the processed video recording is compiled in real time; and
a processing unit arranged to store the processed video recording.

2. The karaoke system as claimed in claim 1, further comprising a display screen adapted to show lyrics and the additional audio or additional images.

3. The karaoke system as claimed in claim 1, wherein the microphone is not part of the at least one mobile device.

4. The karaoke system as claimed in claim 3, wherein the recording is edited by addition of special effects post-production.

5. The karaoke system as claimed in claim 1, wherein the recording unit is arranged to superimpose the video of the karaoke performer onto the background image.

6. The karaoke system as claimed in claim 2, wherein the recording unit is arranged to display the processed video recording on the display screen so that, in use, the karaoke performer can review the recording in real-time during the karaoke performance.

7. The karaoke system as claimed in claim 2, wherein the recording unit comprises editing software enabling the processed video recording to be edited.

8. The karaoke system as claimed in claim 2, wherein the processing unit is arranged to display the processed video recording to be edited on the display screen.

9. The karaoke system as claimed in claim 8, wherein the processing unit is arranged to display the processed video recording on the at least one mobile device.

10. The karaoke system as claimed in claim 1, wherein the processing unit is arranged to make the processed video recording available to third parties for download.

11. The karaoke system as claimed in claim 8, wherein the processing unit is arranged to make the processed recording available through a social media portal.

12. The karaoke system as claimed in claim 8, wherein the processing unit is arranged to make only a part of the processed video recording available.

13. The karaoke system as claimed in claim 2, wherein the additional image comprises text messages, icons, pictures, animation or video segments and the additional audio comprises sound clips or sound effects.

14. The karaoke system as claimed in claim 2, wherein the chroma key screen is adapted to emit the additional audio and/or to display the additional images.

15. A method for operating a karaoke system comprising the steps of:
a) selecting a karaoke song to be performed;
b) emitting an audio track of the karaoke song over a speaker;
c) displaying lyrics for the karaoke song on a display screen to enable a karaoke performer to sing a substitute vocal track, wherein the substitute vocal track is also emitted over the speaker superimposed on the audio track;
d) enabling an additional user to generate an additional image or additional audio, wherein the additional image is combined with the lyrics displayed on the display screen and the additional audio is combined with the substitute vocal track emitted on the speaker;
e) compiling a video recording of the combined audio track, substitute vocal track and additional audio; and
f) capturing a raw video recording of the karaoke performer on a background image formed from a chroma key screen and combining the video recording with the raw video recording in real-time thereby creating a processed video recording.

16. The method as claimed in claim 15, comprising the step of compiling the processed video recording to include the additional image and displaying the processed video recording on the display screen.

17. The method as claimed in claim 15, comprising the step of transmitting the additional image or additional audio from a mobile device that is in communication with the karaoke system.

18. The method as claimed in claim 17, wherein the recording is made using a microphone which is not part of the mobile device.

19. The method as claimed in claim 18, comprising the step of editing the processed video recording by addition of special effects post-production.

20. The method as claimed in claim 19, comprising the step of the karaoke performer uploading the background image to the chroma key screen.

21. The method as claimed in claim 15, comprising the step of editing the processed video recording.

22. The method as claimed in claim 15, comprising the step of enabling the processed video recording to be accessed by third parties or distributed to third parties via social media.
